(19) United States
(12) Patent Application Publication
(10) Pub. No.: US 2010/0122598 A1
(43) Pub. Date: May 20, 2010

(54) Pinion

(76) Inventor: Thomas Salutzki, Witten (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/598,568

(22) PCT Filed: Apr. 18, 2008
(86) PCT No.: PCT/EP08/03140

§ 371 Date: Nov. 2, 2009

(30) Foreign Application Priority Data
May 2, 2007 (DE) 10 2007 020 828.8

(51) Int. Cl. F16H 55/02

(52) U.S. Cl. 74/431

(57) ABSTRACT

A toothing of a pinion, which corresponds to a toothed piston of a door closer or of a door operator. The toothing is mounted position-oriented with regard to the two square shaft ends located at the ends of the pinion.

The invention relates to a pinion, which corresponds to a toothed piston of a door closer or of a door operator and has at least one toothing and, at each end of the pinion, a square shaft end, at which at least one taper is provided, and a cylindrically shaped area is disposed between each square shaft end and the toothing. The position of the toothing is aligned with the two square shaft ends.

In the door closers as well as the door operators, which are currently available on the market and provided with pinions and toothed pistons, pinions are used which are manufactured in several operational steps at high production expenses and cost as well as high investments in machine equipment. The blank is a turned component, which subsequently is provided with a toothing. As a result, the thus manufactured pinions require that, after each operational step, the item in question be transported and stored temporarily if required, which entails a logistic challenge and logistic expenses. The cooperation of the pinion with a toothed piston is illustrated in the document DE 195 38 482 C2, as well as in DE 102 28 870 A1.

It is the object of the present invention to provide a pinion of the species described in the introduction, in which the toothing is mounted position-oriented with regard to the two square shaft ends.

As the solution to this problem, a pinion is proposed having the features of claim 1. Preferred further developments are set forth in the dependent claims.

In the inventive pinion, it is intended that the toothing be mounted position-oriented with regard to the two square shaft ends located at the respective ends of the pinion. Thereby, when installing the door closer or the door operator, a pretension can be applied to the piston and thus to the spring (force accumulator) of the door closer or of the door operator.

It is of advantage that the pinion be manufactured as a cold extruded component. This allows for manufacturing the pinion in a single operational step.

Another practical embodiment is to have the toothing extend continuously. Door closers or door operators, in which the axle mounting is located in the area of the piston, can be equipped with this embodiment. This would be the case of a door closer having a small constructional height.

It is advantageous that the toothing has a collar at one end. The collar stabilizes the toothing. Door closers or door operators, in which the axle mounting is located outside the piston, can be equipped with this embodiment.

The drawings show:

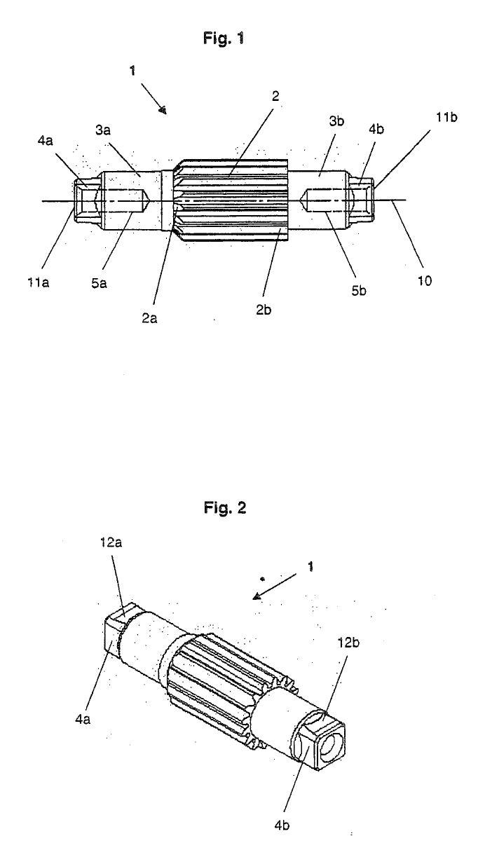

FIG. 1: an inventive pinion in a plane view,

FIG. 2: the inventive pinion of FIG. 1 in a perspective view,

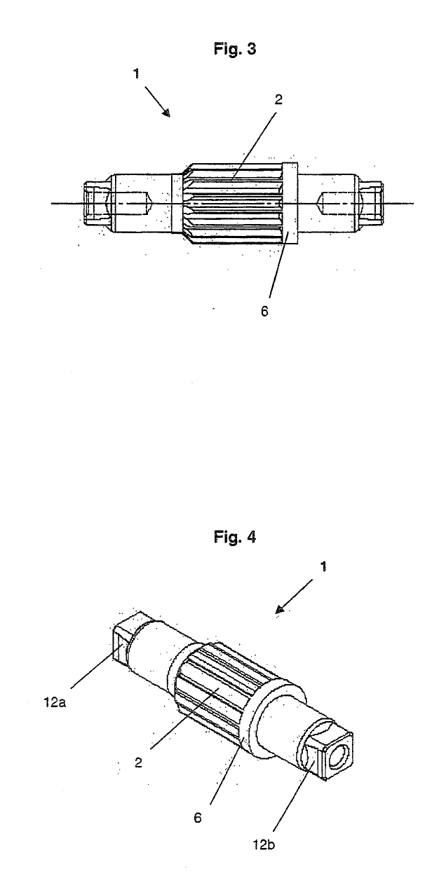

FIG. 3: an inventive pinion of FIG. 1 with a collar at one end of the toothing,

FIG. 4: the inventive pinion of FIG. 3 in a perspective view,

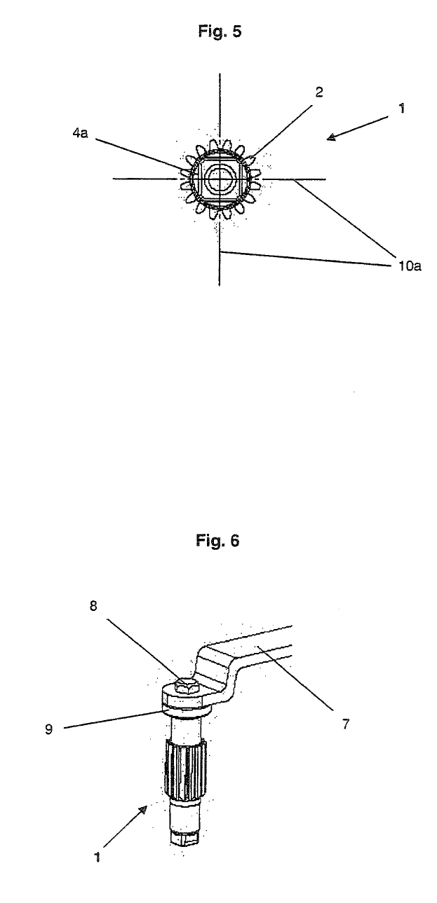

FIG. 5: an inventive pinion of FIG. 1 in a lateral view,

FIG. 6: an inventive pinion of FIG. 1 in an installed situation with a lever arm of a door closer or of a door operator.

FIG. 1 shows a pinion 1, which is intended for door closers as well as for door operators. In this case, it is about diverse door closers and door operators, which have a pinion as well as a toothed piston, as illustrated according to the documents DE 195 38 482 C2 and DE 102 28 870 A1. At each end, the pinion 1 has a square shaft end 4a and 4b. Threaded bores 5a and 5b are provided at the frontal sides 11a and 11b, which bores are not manufactured in one operational step during the production of the pinion 1. The threaded bores 5a and 5b as well as appropriate threads are manufactured in another operational step. A toothing 2 is provided at the circumference of the pinion 1 in the middle area of the pinion 1 in the direction of the central axis 10. At the two ends, this toothing 2 is limited by respective shafts 3a and 3b, which have a smaller diameter than the inner partial circle of the toothing 2. The pinion 1 has a central axis 10, which serves to determine the position of the toothing 2, of the shafts 3a and 3b, of the square shaft ends 4a and 4b, as well as of the threaded bores 5a and 5b. At one end, the toothing 2 has a leading slope 2a, whereas, at the other end of the toothing 2, a continuous toothing 2b is provided. The pinion 1 with a continuous toothing 2b is used with door closers or door operators, in which the axle mounting is installed centrally with regard to the piston of the door closer or of the door operator.

FIG. 2 shows the pinion 1 of FIG. 1 in a perspective view. A taper 12a, 12b is mounted on two opposite sides of the square shaft ends 4a and 4b at the respective ends of the pinion 1.

FIG. 3 shows the pinion 1 of FIG. 1, where a collar 6 is provided at one end of the toothing 2, to represent a non-continuous toothing. In case of stress on the pinion 1, the collar 6 serves to stabilize the toothing 2. The pinion 1 with a collar 6 is used with door closers or door operators, which have an axle mounting outside or centrally of the piston of a door closer or of a door operator.

FIG. 4 shows the pinion 1 of FIG. 3 in a perspective view. The collar 6 is mounted to one end of the toothing 2. The tapers 12a and 12b are mounted at two opposite sides of the square shaft ends 4a and 4b located at the respective ends of the pinion 1.

FIG. 5 shows the pinion 1 of FIG. 1 in a lateral view. This view shows that the toothing 2 is aligned position-oriented with regard to the square shaft end 4a. The position-orientation of the toothing 2 may be embodied in a way that a plain tooth of the toothing 2 is positioned on one of the frontal-sided central lines 10a. In another possible embodiment, the toothing 2 may be aligned such that the recess of a tooth of the toothing 2 is located on one of the frontal-sided central lines 10a. This applies to toothings that have both an even number and an uneven number of teeth at the toothing 2 of the pinion 1.

FIG. 6 shows the pinion 1 of the FIG. 1 in a mounted situation with a lever 7 of a door closer or of a door operator. The lever 7 is positively and non-positively connected to the pinion 1 with an attachment screw 8 and a washer 9 by means of the threaded bore 5b (see FIG. 1), which bore is manufactured in addition to the corresponding thread in another operational step.

The pinion 1, made from a blank, which is a turned component, is manufactured as a cold extruded component in one operational step, which is executed in several press steps without having to rechuck the blank (turned component). In this step, the square shaft ends 4a, 4b, the tapers 12a, 12b, the shafts 3a, 3b and the toothing 2 with the leading slope 2a as well as the collar 6 are manufactured. In this case, the position of the toothing 2 is aligned at the same time with regard to the square shaft ends 4a and 4b. Based on the required embodiments of the toothing 2 at the pinion 1—toothing with continuous toothing 2b or toothing with collar 6—the pinion 1 is thus manufactured as a cold extruded component. In the embodiment with a continuous toothing 2b additional press steps are realized.

The threaded bores 5a and 5b and the respectively associated threads are realized in another operational step, in order to be able to non-positively attach the pinion 1 at the lever 7 by means of the attachment screw 8 and the washer 9, whereby the lever 7 is positively connected by means of the tapers 12a and 12b at the square shaft ends 4a and 4b of the pinion 1.

### LIST OF REFERENCES

1 pinion
2 toothing
2a leading slope
2b continuous toothing
3a shaft
3b shaft
4a square shaft end
4b square shaft end
5a threaded bore
5b threaded bore
6 collar
7 lever arm
8 attachment screw
9 washer
10 central axis
10a frontal-sided central lines
11a front side
11b front side
12a taper
12b taper

1-3. (canceled)

4. A pinion, which corresponds to a toothed piston of a door closer or of a door operator, the pinion comprising:
at least one toothing having two toothing ends;
a square shaft end formed on each end of the pinion and comprising at least one taper;
a cylindrical shaft disposed between the toothing and each of the square shaft ends; and
a collar provided at one of the toothing ends;
wherein the toothing is mounted at a predetermined position with regard to the square shaft ends.

5. The pinion according to claim 4, wherein the pinion is a cold extruded component.

6. The pinion according to claim 4, wherein the toothing comprises a continuous toothing at one of the toothing ends.

7. The pinion according to claim 4, wherein the toothing comprises a leading slope at one of the toothing ends.

8. The pinion according to claim 4, wherein the cylindrical shaft has a smaller diameter than an inner diameter of the toothing.

9. The pinion according to claim 4, wherein the predetermined position of the toothing is arranged such that one of a tooth and a recess of the toothing is aligned with a central line of one of the square shaft ends.
